(19) United States
(12) Patent Application Publication
(10) Pub. No.: US 2026/0276091 A1
(43) Pub. Date: Sep. 17, 2026

(54) HOT WATER MIXING VALVE

(71) Applicant: WATTS REGULATOR CO., North Andover, MA (US)

(72) Inventor: Mahyar ESMAILI, Wilmont, NH (US)

(73) Assignee: Watts regulator Co., North Andover, MA (US)

(21) Appl. No.: 19/675,772

(22) Filed: May 13, 2026

Related U.S. Application Data
(63) Continuation of application No. 18/672,236, filed on May 23, 2024.

(51) Int. Cl. F16K 11/044; F16K 31/04; G05D 23/13

(52) U.S. Cl. CPC F16K 11/044; F16K 31/04; G05D 23/1306; G05D 23/1353; G05D 23/1373; G05D 23/1386; G05D 23/134

(57) ABSTRACT

A hot water mixing valve assembly includes a valve body defining hot and cold water inlets, a mixed water outlet, and a mixing chamber. A shuttle is movable in the mixing chamber between first and second valve seats to vary respective amounts of hot and cold water delivered to the mixing chamber. An actuator is operatively coupled to the shuttle, and a controller commands movement of the actuator based at least in part on temperature data from a temperature sensor positioned to sense mixed water discharged toward the outlet. The controller may slow a speed of the actuator as the shuttle approaches the valve seats. The valve may include sleeve inserts, end caps, and a removable shuttle assembly for servicing. The shuttle may include opposed plugs having distal-facing grooves that receive lips of corresponding valve seats and proximal-facing grooves that capture a seal between the plugs.

### CROSS-REFERENCE TO RELATED APPLICATIONS

The present application is a Continuation of U.S. patent application Ser. No. 18/672,236, filed May 23, 2024, and entitled “HOT WATER MIXING VALVE”, the entire disclosure of which is hereby incorporated by reference in its entirety.

### TECHNICAL FIELD OF THE DISCLOSURE

The present disclosure generally relates to fluid control valves and, more particularly, to hot water mixing valves. Even more particularly, the present disclosure relates to an electronic hot water mixing valve that adjusts the temperature of hot water accurately and quickly, while providing a constant flow rate of the hot water.

### BACKGROUND OF THE DISCLOSURE

In commercial and residential settings, hot water temperature control is important to prevent scalding and ensure efficient operation of the water system and a reliable and consistent supply of hot water at a relatively constant flow rate.

What is still desired is a new and improved electronic hot water mixing valve (“MV”). Preferably the electronic MV will adjust the temperature of hot water accurately and quickly, while providing a constant flow rate of the hot water.

### SUMMARY OF THE DISCLOSURE

The present disclosure provides a new and improved hot water mixing valve (“MV”). According to one exemplary embodiment, the MV includes a body having a first inlet and a second inlet, an outlet, and a mixing chamber. A first passageway connects the first inlet to the mixing chamber, a second passageway connects the second inlet to the mixing chamber, and a third passageway connects the mixing chamber to the outlet. A first valve seat is located between the first passageway and the mixing chamber, and a second valve seat is located between the second passageway and the mixing chamber.

The MV also includes a shuttle located in the mixing chamber between the first and second valve seats. The shuttle is movable from a first position where the shuttle contacts the first valve seat to block fluid flow at least partially from the first passageway into the mixing chamber and a second position where the shuttle contacts the second valve seat to block fluid flow at least partially from the second passageway into the mixing chamber.

The shuttle includes first and second plugs. The first plug faces towards the first valve seat and has a trim surface extending between a distal end and a proximal end, the proximal end being spaced further from the first valve seat than the distal end. An outer diameter of the trim surface is larger at the proximal end than at the distal end. The second plug faces towards the second valve seat and has a trim surface extending between a distal end and a proximal end, the proximal end of the second plug being spaced further from the second valve seat than the distal end of the second plug. An outer diameter of the trim surface of the second plug is larger at the proximal end of the second plug than at the distal end of the second plug.

The trim surfaces of the plugs are one of, or a combination of, a fast-opening shape, a linear shape, and an equal percentage shape. According to one exemplary embodiment, the trim surface of the first plug and the second plug has an equal percentage shape.

According to another exemplary embodiment, the trim surfaces of the first plug and the second plug have the same shape. According to an additional exemplary embodiment, the first plug and the second plug are separate pieces and are secured such that the proximal ends of the plugs touch.

According to additional exemplary features, the body includes a central conduit extending between first and second open ends. The central conduit defines the mixing chamber. A first sleeve insert is received in the first open end of the central conduit and partially defines the first passageway, and an end of the first sleeve insert defines the first valve seat. A second sleeve insert is received in the second open end of the central conduit and partially defines the second passageway, and an end of the second sleeve insert defines the second valve seat. A first end cap closes the first open end of the central conduit and defines a bore, and a second end cap closes the second open end of the central conduit and defines a bore.

The shuttle further includes a stem having a first end and a second end, and the plugs are located on the stem. The first end of the stem is slidingly received in the bore of the first end cap and the second end of the stem is slidingly received in the bore of the second end cap. The shuttle can be pushed towards one of the valve seats and pulled towards the other of the valve seats.

According to one exemplary embodiment, an assembly including the MV also includes an actuator connected to one of the ends of the stem of the shuttle. According to one exemplary embodiment, the actuator is a linear actuator. According to another exemplary embodiment, the actuator includes a stepper motor.

According to another exemplary embodiment, the assembly also includes a temperature sensor located in the third passageway, and a controller connected to the temperature sensor and the actuator and programmed to instruct the actuator to move the shuttle based at least in part on data received by the controller from the temperature sensor. According to a further exemplary embodiment, the controller is programmed to slow the speed of the actuator as the plugs approach the valve seats.

Among other aspects and advantages, the new and improved electronic MV of the present disclosure adjusts the temperature of hot water accurately and quickly, while providing a constant flow rate of the hot water.

Additional aspects and advantages of the present disclosure will become readily apparent to those skilled in this art from the following detailed description, wherein only an exemplary embodiment of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF DRAWINGS

Reference is made to the attached drawings, wherein elements having the same reference character designations represent like elements throughout, and wherein:

FIG. 1 is a top, front and first side perspective view of an exemplary embodiment of an electronic hot water mixing valve (“MV”) assembly constructed in accordance with the present disclosure;

FIG. 2 is a top, rear and second side perspective view of the electronic MV assembly of FIG. 1;

FIG. 3 is a top, front and first side perspective and exploded view of the electronic MV assembly of FIG. 1;

FIG. 4 is a top, front and first side perspective view of an exemplary embodiment of an MV of the assembly of FIG. 1;

FIG. 5 is a top, rear and second side perspective view of the MV of FIG. 4;

FIG. 6 is a front plan view of the MV of FIG. 4;

FIG. 7 is a sectional view of the MV of FIG. 4 taken along line A-A of FIG. 6;

FIG. 8 is a sectional view of the MV of FIG. 4 taken along line B-B of FIG. 7, wherein a shuttle of the MV is shown in a mid-mix position equally spaced from first and second valve seats;

FIG. 9 is a partial sectional view of the MV of FIG. 4 taken along line B-B of FIG. 7, wherein the shuttle of the MV is shown in a full cold position blocking the first (hot water) valve seat;

FIG. 10 is a partial sectional view of the MV of FIG. 4 taken along line B-B of FIG. 7, wherein the shuttle of the MV is shown in a full hot position blocking the second (cold water) valve seat;

FIG. 11 is an exploded perspective view of a shuttle assembly of the MV of FIG. 4;

FIG. 12 is a plan view of the shuttle of the MV of FIG. 4;

FIG. 13 is a sectional view of the shuttle of the MV of FIG. 4, taken along line A-A of FIG. 12;

FIG. 14 is an exploded perspective view of the shuttle of the MV of FIG. 4;

FIG. 15 is an enlarged plan view of plugs of the shuttle of the MV of FIG. 4;

FIG. 16 is an enlarged perspective view of a plug of the shuttle of the MV of FIG. 4;

FIG. 17 is a side elevation view of the plug of FIG. 16;

FIG. 18 is an enlarged sectional view of a portion of the plug taken along line A-A of FIG. 16;

FIG. 19 is an enlarged view of a portion of the MV contained in circle “19” in FIG. 9;

FIG. 20 is a graph of flowrate versus temperature versus shuttle position for a two-inch version of the electronic MV assembly of FIG. 1;

FIG. 21 is a graph of an exemplary embodiment of shuttle speed and motor torque versus shuttle position for the electronic MV assembly of FIG. 1; and

FIG. 22 is front plan view of an exemplary embodiment of a valve station constructed in accordance with the present disclosure, including the MV assembly of FIG. 1.

### DETAILED DESCRIPTION OF EXEMPLARY EMBODIMENTS

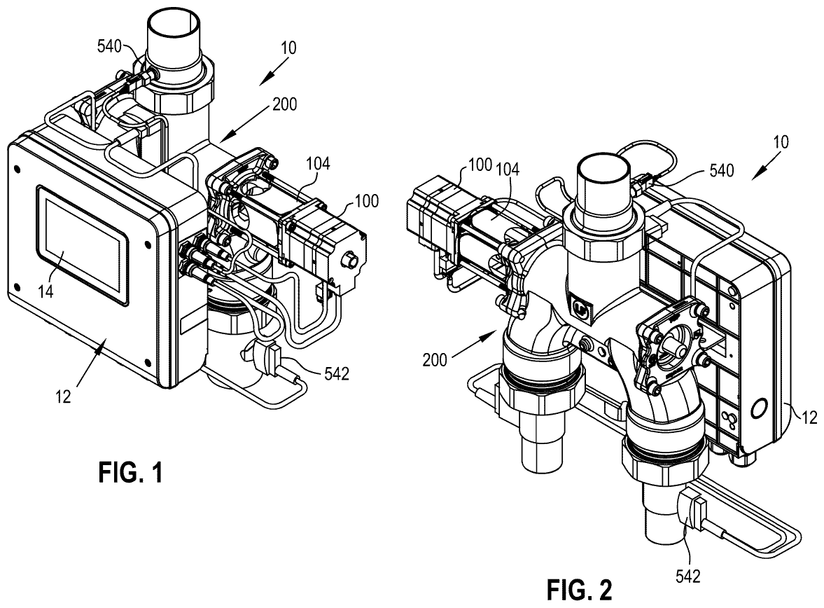

Referring to the figures, an exemplary embodiment of a new and improved electronic hot water mixing valve (“MV”) assembly 10 according to the present disclosure is shown. Among other benefits, the new and improved MV assembly 10 of the present disclosure is easy to maintain and disassemble for servicing and replacement of internal parts. The MV assembly 10 of the present disclosure accurately and quickly mixes hot and cold water while providing mixed water at a constant flow rate. Referring to FIGS. 1 through 3, the MV assembly 10 includes a controller 12, an actuator 100, and a mixing valve (“MV”) 200.

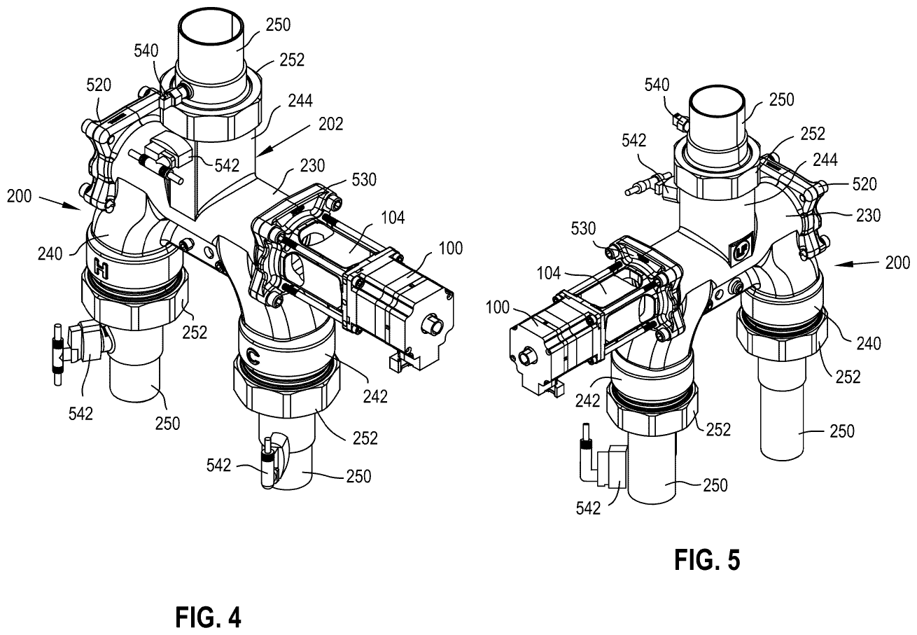

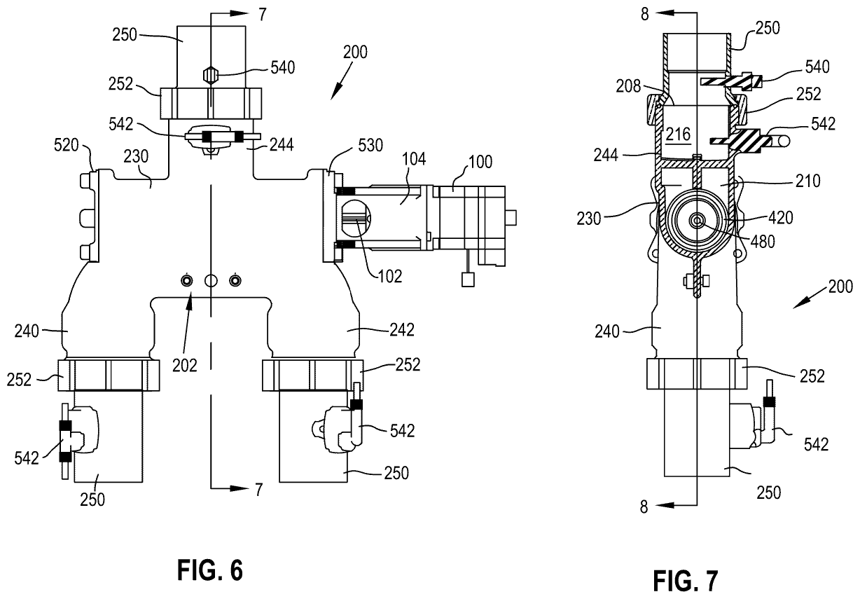

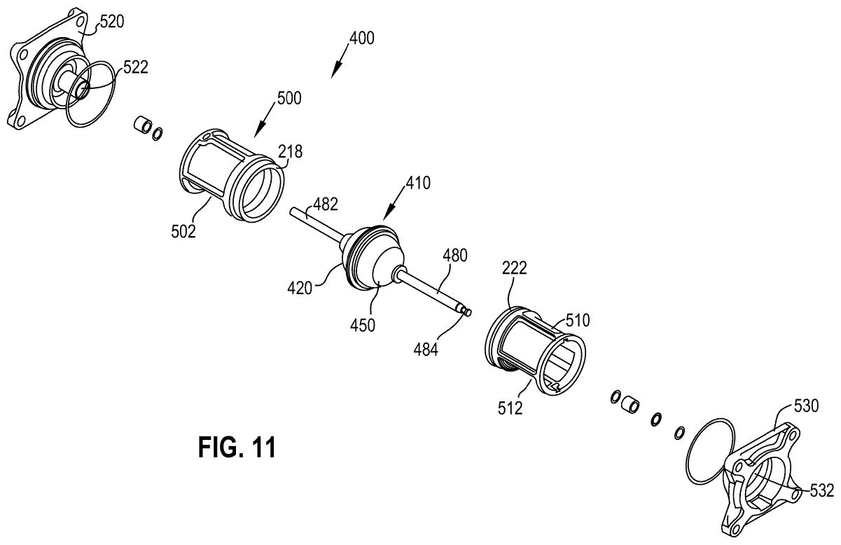

Referring also to FIGS. 4 through 15, the MV 200 includes a body 202 and a shuttle assembly 400 received in the body 202. The shuttle assembly 400 is advantageously easy to remove from, and install into the body 202, for servicing and replacement.

The body 202 has a first inlet 204 and a second inlet 206, an outlet 208. As shown best in FIGS. 7 through 10, the body 202 also includes a mixing chamber 210, a first passageway 212 connecting the first inlet 204 to the mixing chamber 210, a second passageway 214 connecting the second inlet 206 to the mixing chamber 210, and a third passageway 216 connecting the mixing chamber 210 to the outlet 208. A first valve seat 218 is located between the first passageway 212 and the mixing chamber 210, and a second valve seat 222 is located between the second passageway 214 and the mixing chamber 210.

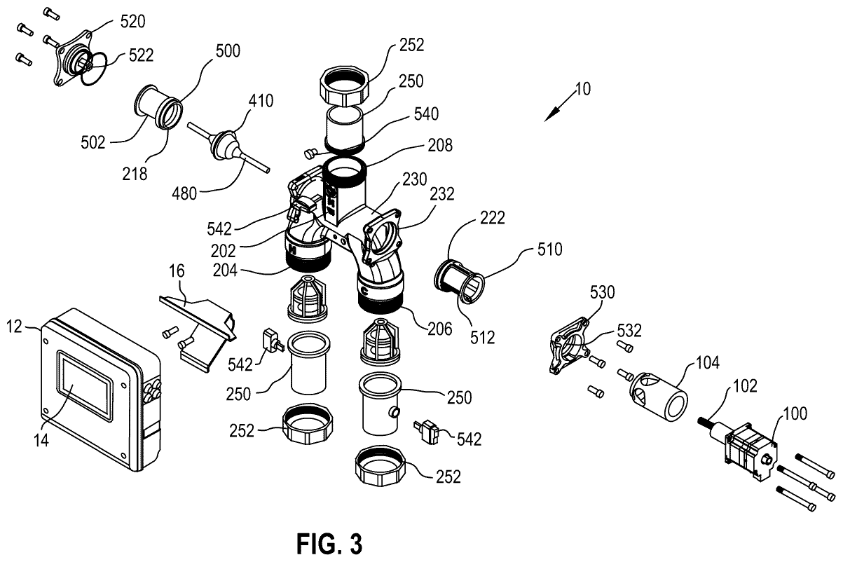

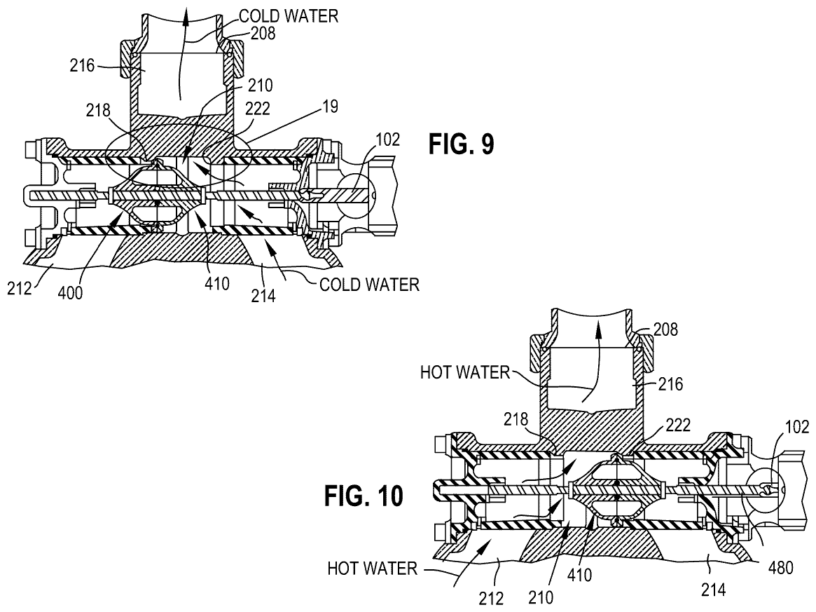

As shown in FIGS. 3 and 7 through 15, a shuttle 410 of the shuttle assembly 400 is in the mixing chamber 210 between the first and second valve seats 218, 222. The shuttle 410 is movable from a first position, shown in FIG. 9, where the shuttle 410 contacts the first valve seat 218 to block fluid flow at least partially from the first passageway 212 into the mixing chamber 210 and a second position, shown in FIG. 10, where the shuttle 410 contacts the second valve seat 222 to block fluid flow at least partially from the second passageway 214 into the mixing chamber 210.

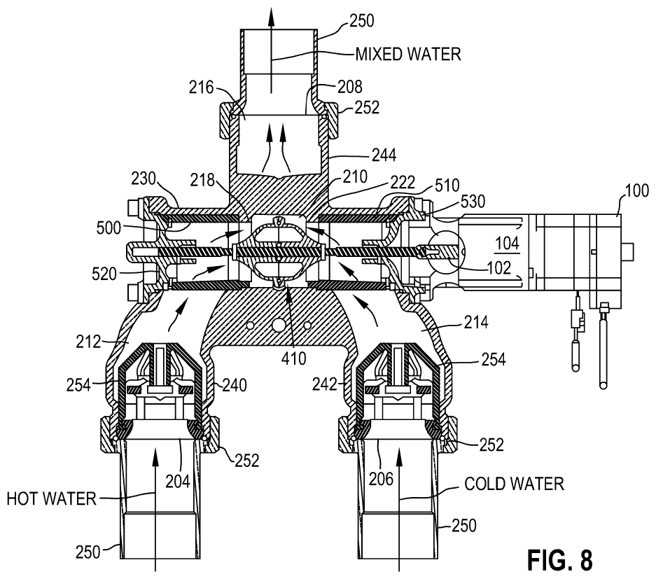

In the example shown in FIGS. 8 through 10, the first inlet 204 and the first passageway 212 are used to deliver hot water to the mixing chamber 210, while the second inlet 206 and the second passageway 214 are used to deliver cold water to the mixing chamber 210. The third passageway 216 and outlet 208 are used to deliver mixed water from the mixing chamber 210. Arrows show the flow of hot water, cold water and mixed water. The temperature of the mixed water delivered to the outlet 208 will vary depending on the mix of hot and cold water produced by the position of the shuttle 410 between the first and the second valve seats 218, 222. In FIG. 8, the shuttle 410 is shown in a mid-mix position equally spaced from the first and the second valve seats, while in FIG. 9 the shuttle 410 is shown in a full cold position blocking the first (hot water) valve seat, and in FIG. 10 the shuttle 410 is shown in a full hot position blocking the second (cold water) valve seat. It should be noted that, in an alternative embodiment, hot water can be directed to the second inlet 206 and cold water to the first inlet 204.

Referring to FIGS. 8-15, the shuttle 410 includes a first plug 420 and a second plug 450. The first plug 420 faces towards the first valve seat 218 and has a trim surface 422 extending between a distal end 424 and a proximal end 426. The proximal end 426 is spaced further from the first valve seat 218 than the distal end 424. In the example shown, an outer diameter of the trim surface 422 is larger at the proximal end 426 than at the distal end 424. However, in alternative embodiments, the outer diameter of the trim surface 422 can vary between the ends depending upon the plug used and its shape.

The second plug 450 faces towards the second valve seat 222 and has a trim surface 452 extending between a distal end 454 and a proximal end 456. The proximal end 456 of the second plug 450 is spaced further from the second valve seat 222 than the distal end 454 of the second plug 450. In the example shown, an outer diameter of the trim surface 452 of the second plug 450 is larger at the proximal end 456 of the second plug 450 than at the distal end 454 of the second plug 450. However, in alternative embodiments, the outer diameter of the trim surface 452 of the second plug 450 can vary between the ends depending upon the plug used and its shape.

The trim surfaces 422, 452 of the plugs 420, 450 can be one of, or a combination of, a fast-opening shape, a linear shape, and an equal percentage shape. A fast-opening shape will give a large change in flowrate for a small movement of the plug from a closed position against the valve seat, while a linear shape will produce a flowrate that is directly proportional to the plug movement. And an equal percentage shape increases the flowrate by a certain percentage of the previous flow for each increment of plug movement so that the relationship between plug movement and flowrate is not linear but logarithmic.

In the exemplary embodiment shown, the trim surfaces 422, 452 of the plugs 420, 450 have an equal percentage shape, and the trim surfaces 422, 452 of the plugs 420, 450 have the same shape and have the same size. In other words, the plugs 420, 450 are identical. It should be noted, however, that the trim surfaces 422, 452 could have different shapes and the plugs 420, 450 could be of different sizes. For example, trim surface 422 of the first plug 420 could have a linear shape and the trim surface 452 of the second plug 450 could have an equal percentage shape. Or the trim surfaces 422, 452 could each have a linear shape, but the plugs 420, 450 could be of different sizes.

In the exemplary embodiment shown, the valve seats 218, 222, and their resulting openings, are the same size and shape. But in alternative embodiments, the valve seats 218, 222 can be sized or shaped differently. In the exemplary embodiment shown, a flow from the first passageway 212 into the mixing chamber 210 and a flow from the second passageway 214 into the mixing chamber 210 are equal when the shuttle 410 is equally positioned between the valve seats 218, 222, as is shown in FIG. 8. But in alternative embodiments, the flows could be different when the shuttle 410 is equally positioned between the valve seats 218, 222.

In the exemplary embodiment shown, the first plug 420 and the second plug 450 are separate pieces and are secured together such that the proximal ends 426, 456 of the plugs 420, 450 touch. In alternative embodiments, the plugs 420, 450 can be spaced apart, or the plugs 420, 450 can be unitarily formed as a single piece.

In the exemplary embodiment shown, the first plug 420 includes a radially extending flange 428 at the proximal end 426 for contacting the first valve seat 218 when the shuttle 410 is in the first position, and the second plug 450 includes a radially extending flange 458 at the proximal end 456 of the second plug 450 for contacting the second valve seat 222 when the shuttle 410 is in the second position. In this exemplary embodiment, the flange 428 of the first plug 420 fully blocks fluid flow from the first passageway 212 into the mixing chamber 210 when the shuttle 410 is in the first position, as shown in FIG. 9, and the flange 458 of the second plug 450 fully blocks fluid flow from the second passageway 214 into the mixing chamber 210 when the shuttle 410 is in the second position, as shown in FIG. 10. In alternative embodiments, the flows from the first and the second passageways 212, 214 do not have to be fully closed when the shuttle 410 is in one of the first and the second positions.

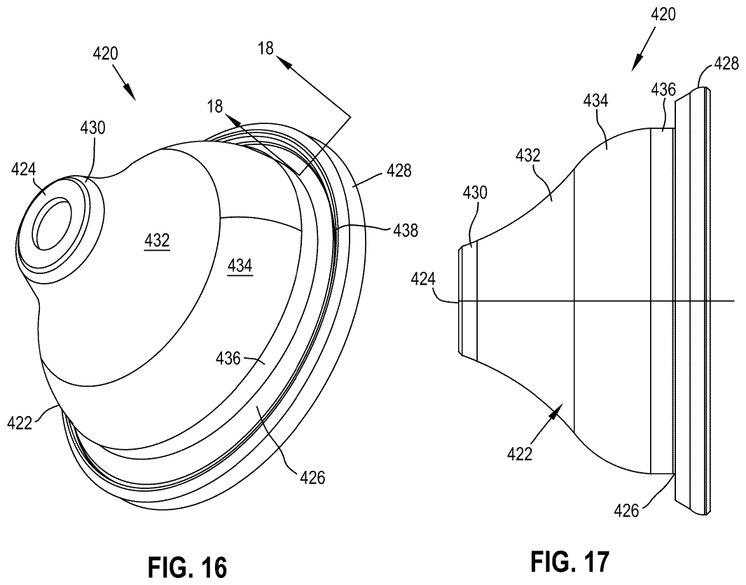

FIGS. 16 through 18 provide enlarged views of one of the two identical plugs 420, 450. As mentioned, the trim surfaces 422, 452 of the plugs 420, 450 have equal percentage shapes. In the embodiment shows, the distal end 424 has a flat face, and the trim surface 422 has four consecutive sections 430-436. A first section 430 extends from the distal end 424 and has a concave profile, a second section 432 has a concave profile, a third section 434 has a convex profile, and a fourth section 436 has a flat profile and extends to the proximal end 426.

According to one exemplary embodiment, the outer diameter of the fourth section 436 is 1.715 inches, while the outer diameter of the distal end 424 is 0.53 inches. The overall length of the plug 420, including the flange, is 1.232 inches. The length of the first section 430 is 0.092 inches, the length of the second section 432 is 0.48 inches, the length of the third section 434 is 0.37 inches, and the length of the fourth section 436 is 0.29 inches. The convex profile of the second section 432 has a radius of 1.2 inches, while the convex profile of the third section 434 has a radius of 0.5 inches.

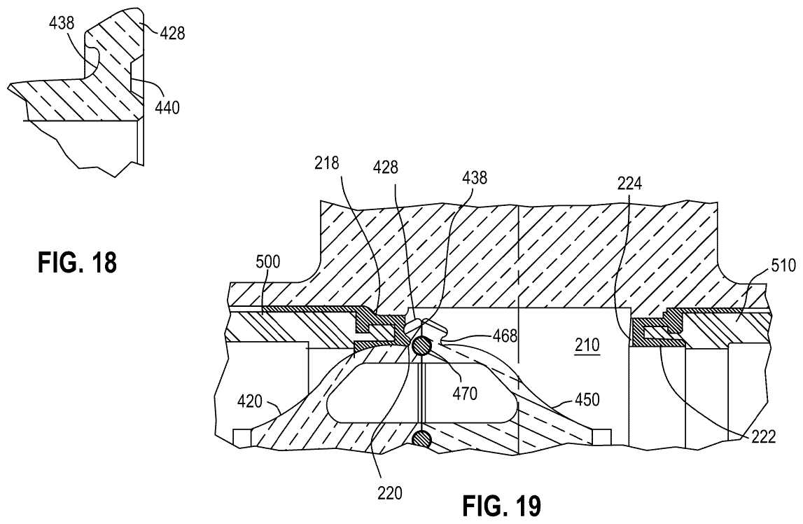

FIG. 18 shows an exemplary embodiment of the flange 428 of the plug 420, wherein the flange includes a distal facing groove 438 and a proximal facing groove 440. The flange 428 has an outer diameter of 2.095 inches.

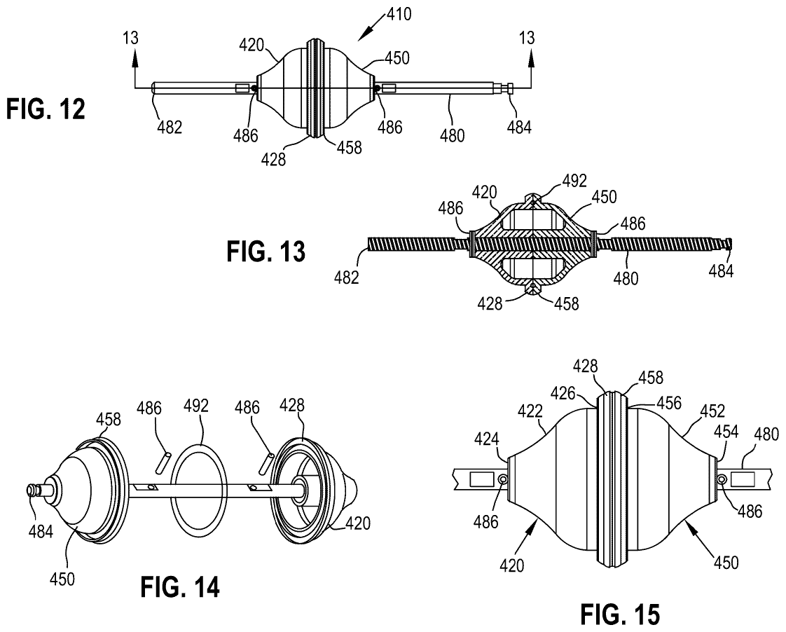

Referring to FIGS. 12 through 15, the shuttle 410 further comprises a stem 480 having a first end 482 and a second end 484, and the plugs 420, 450 are located on the stem. In one exemplary embodiment, the stem 480 is made of stainless steel and the plugs 420, 450 are made of a suitable polymer, such as Noryl® resin. The plugs 420, 450 are secured on the stem 480 with pins 484, and an o-ring 488, a spacer 490 and a seal 492 are located between the plugs 420, 450. The seal 492 is received in the proximal facing grooves 440, 470 of the plugs 420, 450.

In the exemplary embodiment shown, the body 202 further includes a central conduit 230 extending between first and second open ends 232, 234, as shown best in FIGS. 8 through 10, and the central conduit 230 defines the mixing chamber 210. The shuttle assembly 400, as shown best in FIG. 1 through 10 and 11, includes the shuttle 410 and further includes a first sleeve insert 500 received in the first open end 232 of the central conduit 230, a second sleeve insert 510 is received in the second open end 234 of the central conduit 230, a first end cap 520 closing the first open end 232 of the central conduit 230, and a second end cap 530 closing the second open end 234 of the central conduit 230.

The first sleeve insert 500 partially defines the first passageway 212 through a side opening 502 of the sleeve insert. An end of the first sleeve insert 500 defines the first valve seat 218. The second sleeve insert 510 partially defines the second passageway 214 through a side opening 512 in the second sleeve insert. An end of the second sleeve insert 510 defines the second valve seat 222. The sleeve inserts 500, 510 are made of plastic and the valve seats 218, 222 are made of a polymer over-molded onto the sleeve inserts.

As shown best in FIG. 19, the valve seats 218, 222 each include an extending lip 220, 224. The lips 220, 224 are received in the distal facing grooves 438, 468 of the flanges 428, 458 of the plugs 420, 450 when the shuttle 410 is in the first position (FIG. 9) or the second position (FIG. 10).

As shown best in FIG. 8-11, the first end cap 520 has a bore 522, and the second end cap 530 has a bore 532. The first end 482 of the stem 480 of the shuttle 410 is slidingly received in the bore 522 of the first end cap 520, and the second end 484 of the stem 480 is slidingly received in the bore 532 of the second end cap 530.

In the example shown, the second end 484 of the stem 480 extends through the bore 532 of the second end cap 530. The actuator 100 includes a screw 102 secured to the second end 484 of the stem 480 of the shuttle 410, so that the actuator 100 can push the shuttle 410 towards the first valve seat 218 or pull the shuttle 410 towards the second valve seat 222. The actuator 100 is a linear actuator having a stepper motor. According to one example, the actuator 100 is a NEMA 23, captive linear stepper motor, model number 23K2113F4-175SMSEK-WWT-001 (04), supplied by Ding's Motion USA. The actuator 100 also includes a mounting adapter 104 secured between the second endcap 530 and the actuator.

The electronic hot water MV assembly 10 includes a temperature sensor 540 located in the third passageway 216, and the controller 12 is connected to the temperature sensor 540 and the actuator 100. The controller 12 is programmed to instruct the actuator 100 to move the shuttle 410 based at least in part on data received by the controller 12 from the temperature sensor 540.

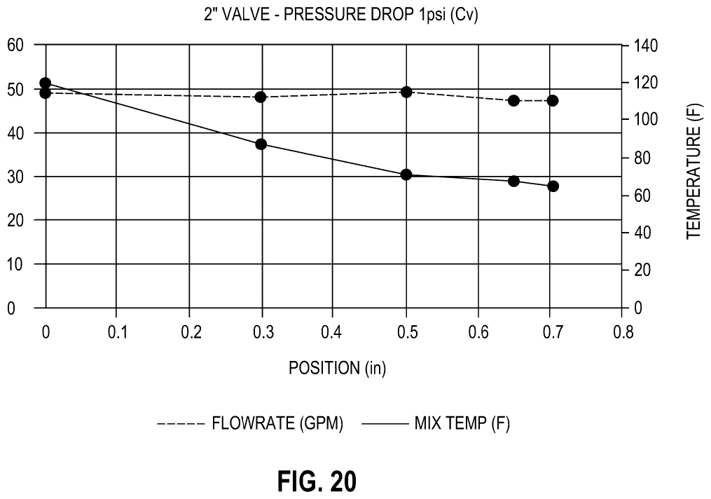

A graph provided in FIG. 20 shows a flowrate and a temperature of water discharged (i.e., from outlet 208) by a two-inch version of the MV assembly 10 according to the present disclosure. The flowrate and the temperature are plotted versus the position of the shuttle 410 in the mixing chamber 210 between the valve seats 218, 222. As shown, the assembly 10 can change the temperature of the mixed water at the third passageway 216 while maintaining the flowrate of water passing through the third passageway.

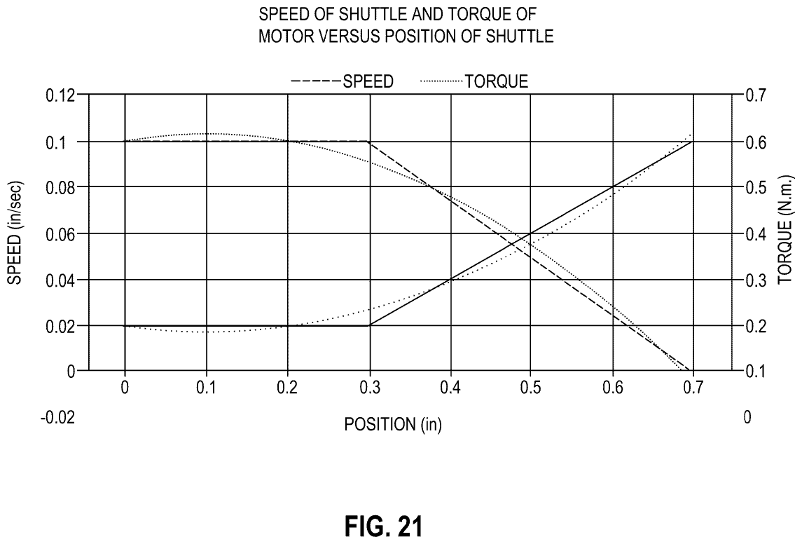

FIG. 21 is a graph of an exemplary embodiment of shuttle 410 speed and motor (actuator 100) torque versus the shuttle 410 position within the mixing chamber 210 for the MV assembly 10 of FIG. 1. As illustrated by the graph, the controller 12 is programmed to slow the speed of the actuator 100 whenever the shuttle 410 approaches the first and the second valve seats 218, 222. For example, at the position of 0.7 inches on the graph is when the flange 428 of the first plug 420 reaches the first valve seat 218 or when the flange 458 of the second plug 450 reaches the second valve seat 222. Slowing the speed increases the motor torque so that the actuator 100 can effectively close the valve seats 218, 222.

The controller 12 has a touch screen display 14 that allows a user to setup and operate the MV assembly 10. The set point for the mixed water flow is programmable for a wide range of temperatures such as 60° F. to 180° F. In one embodiment, the display shows the date and time with the setpoint and current mixed water temperature. The MV assembly 10 maintains the setpoint within 2° F., for example. The controller 12 also includes memory for storing data such as error messages with associated date and time stamps, as well as a processor. The controller 12 is also Wi-Fi enabled. In one embodiment, the controller 12 has battery backup, which may be internal or external. Preferably, the controller 12 communicates with a building automation system for sending and receiving status and control information for remote monitoring. For example, high and low temperature alerts may be programmed into the controller 12.

The controller 12 is mounted to the MV 200 with a bracket 16, as shown in FIG. 3. The controller 12 is in communication with the temperature sensor 540 and the actuator 100 to monitor and control operation of the MV 200. The communication between the controller 12, the actuator 100, and the sensor 540 may be wireless and/or hard wired. In the shown embodiment, the controller, the sensor, and the actuator communicate with wires.

As shown in FIGS. 2 through 8, the body 202 of the MV 200 further includes a first leg 240 connected to the central conduit 230 and defining the first inlet 204 and partially defining the first passageway 212, a second leg 242 connected to the central conduit 230 and defining the second inlet 206 and partially defining the second passageway 214, and a third leg 244 connected to the central conduit 230 and defining the outlet 208 and the third passageway 216. The legs 240, 242, 244 extend substantially perpendicular to the central conduit 230. Tailpieces 250 are attached to the legs 240, 242, 244 with union nuts 252 to couple into a building's water network. As can be seen, additional sensors 542 can be mounted in the tailpieces 250 and the body 202 for sensing the temperature and the pressure of the water, and these sensors are also connected to the controller 12. The MV 200 also includes check modules 254 in the first and the second passageways 212, 214. The check modules may also include strainers to prevent contamination with particles that could impede the proper operation of the electronic MV assembly.

The components of the MV assembly 10 may be fastened together by threads, welding, epoxy, fasteners and the like not described in detail but plainly visible in the figures. Preferably, the body 202 of the MV has a lead-free construction, fabricated from material such as bronze, brass, stainless steel, polytetrafluoroethylene (PTFE), zinc plated steel, die cast aluminum, glass filled Noryl® resin and the like.

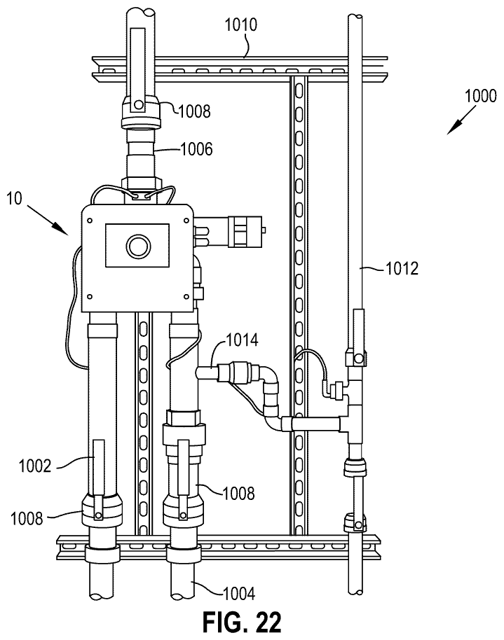

Referring to FIG. 22, there is shown a valve station 1000 including the MV assembly 10, and further including a hot water supply conduit 1002 connected to the first inlet 204 of the valve, a cold water supply conduit 1004 connected to the second inlet 206 of the valve, and a mixed water conduit 1006 connected to the outlet 208 of the valve. Shut-off valves 1008 are in the cold water, the hot water and the mixed water conduits. A frame 1010 supports the conduits and the MV assembly 10. And a recirculation water conduit 1012 is supported by the frame 1010, and a diversion conduit 1014 is connected between the recirculation water conduit 1012 and the cold water conduit 1004.

The present disclosure, therefore, provides a new and improved electronic hot water MV assembly 10. It should be understood, however, that the exemplary embodiment described in this specification has been presented by way of illustration rather than limitation, and various modifications, combinations and substitutions may be affected by those skilled in the art without departure either in spirit or scope from this disclosure in its broader aspects and as set forth in the appended claims. Accordingly, other embodiments are within the scope of the following claims. In addition, the MV assembly disclosed herein, and all elements thereof, are contained within the scope of at least one of the following claims. No elements of the presently disclosed MV assembly are meant to be disclaimed.

What is claimed is:

1. A hot water mixing valve assembly comprising:
a valve body defining a hot water inlet, a cold water inlet, a mixed water outlet, and a mixing chamber fluidly connected to the hot water inlet, the cold water inlet, and the mixed water outlet;
a first valve seat positioned between the hot water inlet and the mixing chamber; a second valve seat positioned between the cold water inlet and the mixing chamber;
a shuttle positioned in the mixing chamber and movable along an axis between the first valve seat and the second valve seat to vary respective amounts of hot water and cold water delivered to the mixing chamber;
an actuator operatively coupled to the shuttle and configured to axially displace the shuttle;
a temperature sensor positioned to sense a temperature of mixed water discharged from the mixing chamber toward the mixed water outlet; and
a controller in communication with the actuator and the temperature sensor, the controller being programmed to command movement of the shuttle based at least in part on temperature data received from the temperature sensor to adjust a temperature of the mixed water discharged through the mixed water outlet while maintaining a substantially constant flow rate of the mixed water through the mixed water outlet.

2. The hot water mixing valve assembly of claim 1, wherein the controller is programmed to compare the temperature data received from the temperature sensor to a programmed setpoint temperature and command the actuator to move the shuttle in a first axial direction or a second axial direction based on a deviation between the temperature data and the programmed setpoint temperature.

3. The hot water mixing valve assembly of claim 1, wherein the controller is programmed to reduce a speed of the actuator as the shuttle approaches at least one of the first valve seat or the second valve seat.

4. The hot water mixing valve assembly of claim 3, wherein the controller is programmed to reduce the speed of the actuator to increase torque available from the actuator for seating the shuttle against the at least one of the first valve seat or the second valve seat.

5. The hot water mixing valve assembly of claim 1, wherein the actuator comprises a linear actuator including a stepper motor, and wherein the actuator is configured to push the shuttle toward the first valve seat and pull the shuttle toward the second valve seat.

6. A serviceable mixing valve comprising:
a valve body including a central conduit extending between a first open end and a second open end, the central conduit defining a mixing chamber;
a first sleeve insert received in the first open end of the central conduit and partially defining a first passageway to the mixing chamber;
a second sleeve insert received in the second open end of the central conduit and partially defining a second passageway to the mixing chamber;
a first end cap closing the first open end of the central conduit;
a second end cap closing the second open end of the central conduit; and
a shuttle assembly received in the central conduit between the first sleeve insert and the second sleeve insert,
wherein the shuttle assembly is removable from, and installable into, the valve body through at least one of the first open end or the second open end for servicing or replacement of the shuttle assembly.

7. The serviceable mixing valve of claim 6, wherein an inner end of the first sleeve insert defines a first valve seat and an inner end of the second sleeve insert defines a second valve seat.

8. The serviceable mixing valve of claim 7, wherein the first valve seat comprises a polymer material over-molded onto the first sleeve insert, and wherein the second valve seat comprises a polymer material over-molded onto the second sleeve insert.

9. The serviceable mixing valve of claim 7, wherein the shuttle assembly comprises a stem, a first plug carried by the stem and facing the first valve seat, and a second plug carried by the stem and facing the second valve seat.

10. The serviceable mixing valve of claim 9, wherein the first plug includes a first radially extending flange having a first distal-facing groove, wherein the second plug includes a second radially extending flange having a second distal-facing groove, wherein the first valve seat includes a first lip configured to be received in the first distal-facing groove when the shuttle assembly is in a first seated position, and wherein the second valve seat includes a second lip configured to be received in the second distal-facing groove when the shuttle assembly is in a second seated position.

11. A mixing valve comprising:
a body defining a mixing chamber, a first passageway to the mixing chamber, and a second passageway to the mixing chamber;
a first sleeve insert at least partially defining the first passageway and including a first valve seat having a first extending lip;
a second sleeve insert at least partially defining the second passageway and including a second valve seat having a second extending lip; and
a shuttle located in the mixing chamber between the first valve seat and the second valve seat, the shuttle including:
a stem;
a first plug carried by the stem and facing the first valve seat, the first plug including a first radially extending flange having a first distal-facing groove and a first proximal-facing groove;
a second plug carried by the stem and facing the second valve seat, the second plug including a second radially extending flange having a second distal-facing groove and a second proximal-facing groove; and
a seal positioned between the first plug and the second plug and received in the first proximal-facing groove and the second proximal-facing groove,
wherein the first extending lip is received in the first distal-facing groove when the shuttle is in a first seated position to form a first lip-and-groove seating interface between the first sleeve insert and the first plug, and
wherein the second extending lip is received in the second distal-facing groove when the shuttle is in a second seated position to form a second lip-and-groove seating interface between the second sleeve insert and the second plug.

12. The mixing valve of claim 11, wherein opposing proximal ends of the first plug and the second plug contact one another, and wherein the seal is captured between the opposing proximal ends by the first proximal-facing groove and the second proximal-facing groove.

13. The mixing valve of claim 12, wherein the first plug and the second plug are secured on the stem with pins to retain the first plug, the second plug, and the seal in an assembled position on the stem, and wherein the seal is compressed between the opposing proximal ends of the first plug and the second plug.

14. The mixing valve of claim 11, wherein the first plug and the second plug are supported on the stem with a spacer positioned between the first plug and the second plug, the spacer maintaining axial spacing of the first plug and the second plug relative to the first valve seat and the second valve seat so that the first extending lip and the second extending lip align with the first distal-facing groove and the second distal-facing groove, respectively, at corresponding seated positions of the shuttle.

15. The mixing valve of claim 11, wherein the stem comprises a metal stem and the first plug and the second plug comprise polymer plugs carried by the metal stem, such that the metal stem provides axial load transfer from an actuator to the first plug and the second plug and the polymer plugs provide seating surfaces for contacting the first valve seat and the second valve seat.
